(19) United States
(12) Patent Application Publication
(10) Pub. No.: US 2025/0258119 A1
(43) Pub. Date: Aug. 14, 2025

(54) SYSTEM AND METHOD FOR MEASURING A PHYSICAL PARAMETER IN A GASEOUS SAMPLE

(71) Applicant: Kamal Mahajan, Ronkonkoma, NY (US)

(72) Inventor: Kamal Mahajan, Ronkonkoma, NY (US)

(21) Appl. No.: 18/441,322

(22) Filed: Feb. 14, 2024

(51) Int. Cl. G01N 27/02

(52) U.S. Cl. CPC G01N 27/02

(57) ABSTRACT

A system and method for measuring a parameter in a gaseous sample are disclosed. The system comprises a measuring device having a chamber body. The chamber body has a narrow middle portion. The narrow middle portion is configured to allow a gaseous sample to pass through it. The system further comprises a transmission antenna and a receiving antenna. The transmission antenna transmits a first signal from a signal generator to the receiver antenna via the narrow middle portion. The receiver antenna receives the first signal and generates a received signal with a transmission delay. The delay in the transmission of the signal from the transmitter to the receiver through the gaseous sample along a predetermined distance gives a measure of the parameter being measured within the gaseous sample. Further, the parameters that can be measured include humidity, temperature, air quality, pressure, and a quantity of a specific contaminant.

### FIELD OF INVENTION

The present disclosure generally relates to systems and methods for detecting substances in gaseous samples. More specifically, the present invention relates to a system and method for measuring a specific physical parameter in a gaseous sample.

### BACKGROUND

Measurement of a particular parameter in a fluid medium, such as air, typically requires the use of a dedicated sensing device. The sensing device typically includes a sensor that senses the desired parameter and provides a relevant signal to a controller and actuator which then converts the signal into respective readings of the measured parameter through a feedback and control system. The readings are then communicated to the user through a display. An example of such is the sensing of atmospheric pressure using a barometer where the air pressure is sensed as a measure of the weight of surrounding air on mercury within a column, which serves as the sensing material. The signal that is the height of mercury in the column is then converted and displayed as pressure units. Similarly, the thermal expansion of a fluid within a glass column is used as a measure of temperature in a thermometer.

Few existing patent applications attempt to address the above-mentioned devices for sensing various parameters in fluids and are explained as follows:

A prior art US 20100307238 A1 assigned to Andy Christopher Van Popta, et. al., entitled “Humidity sensor and method of manufacturing the same” discloses a humidity sensor comprising an insulating substrate, a moisture-sensitive layer, and at least a detection electrode contacting the moisture-sensitive layer, wherein the moisture-sensitive layer is a porous, photocatalytic metal oxide.

Another prior art, US 2017/0038311 A1 of Conrad, discloses a method to detect bubbles, foreign objects, debris, dissimilar material, or property changes in a liquid, lubricant, compressed gas, or fine solid. This method uses the vector signal analysis [also known as a phase-gain meter or automatic network analysis] phase change in the transmitted energy versus the reflected energy in radio waves to detect bubbles, foreign objects, debris, dissimilar material, or property changes in a liquid, lubricant, compressed gas or fine solid using one, two or three antennas or a coil. This method describes the means by which to develop the specific sensor for the intended application. This method also describes the method by which to develop and tune a specific sensor for an exact application. This method also describes the type of sensor that would be used with the described method of detection. This method also describes the application of a sensor employing this method that includes: medical devices, printer ink, manufacturing/refining processes, industrial food processing, engine fuel monitoring, specific property sensing, and lubricant property sensing. In addition, in my own patent application Ser. No. 17/402,523 discloses a design that would not work in an open environment, as the RF in the open environment was interfering with the measured signal that were getting from the receive antenna which made the signal very insensitive. Henceforth, this present invention is redesign and improved with new ideas to overcome the issues.

Thus, there is a need for a system and method for measuring various parameters in the gaseous sample with improved accuracy. Also, there is a need for a system and method for an improved system with enclosed area for the transmission of signals between the two antennas without any interference, thereby increasing the accuracy of the readings.

### SUMMARY

The present disclosure is of a system for measuring a physical parameter in a gaseous sample using an enclosed glass tube in the existing system to improve the accuracy of the readings. The system comprises a measuring device having a chamber body. The chamber body has a narrow middle portion configured to allow the gaseous sample to pass through. The chamber body further comprises at least two ends including a first end or transmission end and a second end or receiving end. In one embodiment, the chamber body further comprises one or more out ports configured to reduce interference and sensitivity of the measurement.

In one embodiment, the system further comprises at least two antennas including a first antenna or a transmission antenna and a second antenna or receiver antenna. In this embodiment, the transmission antenna transmits a first signal from a signal generator to the receiver antenna via the chamber body. The first signal is transmitted via the narrow middle portion that increases the sensitivity of the measurement. In one embodiment, the narrow middle portion is configured to increase the sensitivity of the measurement and reduce the time taken to reach stability and measurement. The receiver antenna receives the transmitted first signal from the transmitter antenna and generates a received signal with a transmission delay. The difference between the transmitted first signal and the received signal is checked. The received signal is delayed due to relative humidity (Rh). The delay in the received signal is interpreted into Rh value.

The transmission delay between the transmitted first signal and the received signal is corresponding to varying parameters of the gaseous sample in the chamber body, thereby enhancing the accuracy of readings with reduced interference.

In one embodiment, the chamber body is a glass tube having an enclosed area for the transmission of the first signal between the transmission antenna and the receiver antenna. The glass tube enhances the accuracy of readings due to reduced interference. In one embodiment, the chamber body is coated with a chromium layer at its outer surface and grounded to isolate it from the outer signal or interference from any signals from the other sources. The chamber body is grounded to isolate it from any outer signal or interference from any signals from other external sources, thereby enhancing the accuracy of the readings due to reduced interference.

In one embodiment, the system further comprises a phase-locked loop (PLL) in communication with the receiver antenna. The PLL matches the received signal with a reference signal and adjusts the received signal with respect to the reference signal to generate a synchronized signal. In one embodiment, the synchronized signal is analyzed to compute the transmission delay between the transmission and the reception of the first signal through the gaseous sample. In one embodiment, the system further comprises a shielding for the wave transmitted from the outer environment, thereby providing an uninterrupted transmission of signals inside the chamber body to improve accuracy. Further, the chamber body is enclosed with an external enclosure with a constant temperature to improve accuracy.

In one embodiment, the present invention utilizes a method for measuring a parameter in the gaseous sample. The method utilizes a system for measuring the parameter in the gaseous sample. The system comprises a measuring device having a chamber body having a narrow middle portion. The measuring device includes at least two ends such as a first end or transmission end and a second end or receiving end. The system further comprises at least two antennas including a first antenna or a transmission antenna mounted at the first end of the measuring device and a second antenna or receiving antenna mounted at the second end of the measuring device opposite to the transmission antenna.

In one embodiment, the method comprises the following steps. At one step, the first signal is transmitted from the transmission antenna via the narrow middle portion with a gaseous sample present inside the chamber body. The transmission antenna transmits the first signal to the receiver antenna via the narrow middle portion of the chamber body configured to increase the sensitivity of the measurement. In one embodiment, the chamber body is a glass tube having an enclosed area for the transmission of the first signal between the transmission antenna and the receiver antenna. The glass tube enhances the accuracy of readings due to reduced interference.

The chamber body is coated with a chromium layer at its outer surface and grounded to isolate it from the outer signal or interference from any signals from the other sources. In one embodiment, the chamber body is grounded to isolate it from any outer signal or interference from any signals from other external sources, thereby enhancing the accuracy of the readings due to reduced interference. In one embodiment, the chamber body further comprises one or more out ports configured to reduce interference and improve the sensitivity of reading. Further, the chamber body is enclosed with an external enclosure with a constant temperature to improve accuracy.

At another step, the receiver antenna receives the transmitted first signal and generates a received signal with a transmission delay. At another step, the received signal is synchronized/matched with a reference signal via a phase-locked loop (PLL) to generate a synchronized signal. At another step, the synchronized signal and the reference signal are analyzed using a processor to compute the transmission delay between the transmission and the reception of the first signal through the gaseous sample. The processor may be a digital signal processor or other types of processors, is configured to analyze the synchronized signal and the reference signal to compute the delay in the transmission of the first signal from the transmitter to the receiver through the gaseous sample, and determine, based on the transmission delay, a measure of the parameter in the gaseous sample.

At another step, the transmission delay between the transmitted first signal and the received signal is determined based on the varying parameters of the gaseous sample in the chamber body, thereby enhancing the accuracy of readings with reduced interference. The method further utilizes a shielding for the wave transmitted from the outer environment, thereby providing an uninterrupted transmission of signals inside the chamber body to improve accuracy.

The present disclosure also presents a method for measuring a parameter in a gaseous sample which implements the system disclosed herein.

### BRIEF DESCRIPTION OF THE DRAWINGS

FIG. 1 shows a schematic block diagram of a system for measuring a parameter in a gaseous sample, according to one embodiment of the present disclosure.

FIG. 2 shows a flow diagram of a method for measuring the parameter in the gaseous sample, according to one embodiment of the present disclosure.

FIG. 3 shows a schematic diagram of an improved system with an enclosed area for measuring a parameter in a gaseous sample, according to one embodiment of the present disclosure.

FIG. 4 shows a flow diagram of a method for measuring the parameter in the gaseous sample using the improved system, according to one embodiment of the present disclosure.

### DETAILED DESCRIPTION

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

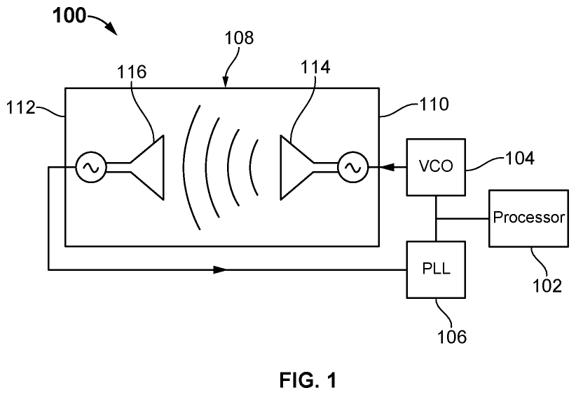

Referring to FIG. 1, a schematic block diagram of a system 100 for measuring a parameter in a sample according to one embodiment of the present disclosure, is illustrated. The system 100 comprises a processor 102. In one embodiment, the processor 102 comprises an integrated memory. The integrated memory is configured to store a set of program modules executable by the processor 102 to operate the system 100. The set of program modules is disposed of (for example, embedded) on a non-transitory storage medium. In an embodiment, the processor 102 comprises more than one computing device, such as a digital signal processor (DSP) for signal processing and an additional microprocessor for program logic.

In one embodiment, the processor 102 comprises one or more interfaces, one or more processors, and a memory coupled to each processor. The interfaces may include, but not limited to, a variety of software and hardware interfaces, for example, interfaces for peripheral devices, such as an external memory, a display, and a printer. The memory may include any computer-readable storage medium known in the art including, but not limited to, volatile memory such as static random-access memory (SRAM) and dynamic random-access memory (DRAM), and/or non-volatile memory, such as read only memory (ROM), erasable programmable ROM, flash memories, hard disks, optical disks, and magnetic tapes. In one embodiment, a plurality of instructions to operate the processor 102 is stored on a non-transitory computer-readable medium. As used herein, the non-transitory computer-readable media comprises all computer-readable media except for a transitory, propagating signal.

The system 100 further comprises a voltage control oscillator (VCO) 104 and a phase-locked loop (PLL) 106. The processor 102 is communicatively coupled to the VCO 104 and PLL 106.

In one embodiment, the VCO 104 is configured to generate a first signal having a first frequency. In one embodiment, the first frequency is about 5.9 GHZ. The frequency of the first signal generated via the VCO 104 is generated based on the input control voltage supplied to the VCO 104. In one embodiment, the control voltage supplied to the VCO 104 has a frequency of the first signal generated by the VCO 104. In one embodiment, the control voltage and the first signal have the same frequency. The frequency is about 5.9 GHz. However, the input voltage can vary such that the frequency can be of any value that is feasible for the execution of the process.

In one embodiment, the VCO 104 is substituted with any such device that transmits signals and communicates with the processor 102 and PLL 106. Such device may produce a delay in signal corresponding with varying parameters such as humidity, level of contamination, and pressure.

In one embodiment, the system 100 further comprises an airtight chamber 108 filled with the sample. The sample is a gaseous sample. In one embodiment, the gaseous sample is a gaseous phase of a single compound or element or a mixture of gases. The airtight chamber 108 has a transmitting end or first end 110 and a receiving end or second end 112. In one embodiment, the system 100 further comprises a transmitter 114 and a receiver 116. The transmitter 114 and receiver 116 are located inside the airtight chamber 108. The transmitter 114 is located at the first end 110 of the airtight chamber 108. The receiver 116 is located at the second end 112 of the airtight chamber 108 opposite to the transmitter 114. The transmitter 114 and the receiver 116 are placed at the opposite ends (110 and 112) of the airtight chamber 108 and separated by a first predetermined distance. In one embodiment, the first distance can range from about 0.5 inches to about 3 inches, although other distances may suffice.

The transmitter 114 is in communication with the VCO 104. The transmitter 114 is a radio frequency (RF) transmitter. In one embodiment, the transmitter 114 is replaced with any such device that transmits any form of signal that is received by the receiver 116. The receiver 116 is a radio frequency (RF) receiver. In one embodiment, the transmitter 114 is installed in the airtight chamber 108 of fixed volume and dimensions. The airtight chamber 108 is a space with the gaseous sample, where a desired parameter of the gaseous sample is to be measured. In one embodiment, the airtight chamber 108 is covered in an RF shielding material to ensure that all the signal from the transmitter 114 reaches the receiver 116 without environmental interference. The transmitter 114 is configured to transmit the first signal generated by the VCO 104 through the gaseous sample or sample air present within the airtight chamber 108 and received via the receiver 116. In one embodiment, the signal transmitted within the airtight chamber 108 is any form of signal with a change in the parameters. The change in the parameter to be measured causes a detectable corresponding change in transmission delay between the transmitter 114 and receiver 116.

The receiver 116 generates a received signal with a transmission delay. In one embodiment, the received signal is the transmitted first signal accompanied with the transmission delay while the signal is passing through the gaseous sample. The receiver 116 is in communication with the PLL 106. The receiver 116 sends the received signal to the PLL 106. The PLL 106 is also coupled to the VCO 104 such that the VCO 104 supplies a reference signal to the PLL 106. The PLL 106 receives the received signal from the receiver 116 and the reference signal from the VCO 104. In one embodiment, the PLL 106 matches the received signal and the reference signal, and adjusts the received signal with respect to reference signal to generate a synchronized signal. The synchronized signal is then used as the signal having the required control voltage to continue the operation of the VCO 104. In one embodiment, the reference signal has the same frequency and phase as that of the first signal.

The synchronized signal is then supplied to the processor 102. The synchronized signal is analyzed by the processor 102 to extract the information pertaining to the transmission delay in the transmission of the first signal from the transmitter 114 to the receiver 116. The integrated memory is configured to store a plurality of data corresponding to a measurement of the parameter and associated transmission delays. In one embodiment, the transmission delay of the signal from the transmitter 114 to the receiver 116 is affected by the density of the gaseous sample. The density of the gaseous sample is a factor that is translated into a measurement of the desired parameter within the gaseous sample due to the direct or derived relationship between the density and other parameters of the gaseous sample. In one embodiment, the parameters relate to a measurable characteristic of the gaseous sample. Some examples of the parameters that can be measured using the system 100 include, but are not limited to, at least one of humidity, temperature, air quality, pressure, and quantity of a specific contaminant. In one embodiment, the system 100 further comprises a display device configured to output the measure of the parameter in the gaseous sample in human perceptible form.

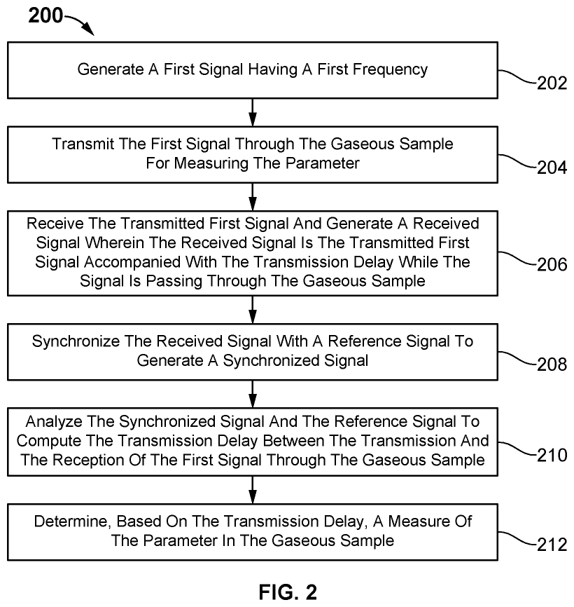

Referring to FIG. 2, a flow diagram of a method 200 for measuring a parameter in the gaseous sample according to one embodiment of the present disclosure, is illustrated. The order in which the method 200 is described is not intended to be construed as a limitation, and any number of the described method blocks can be combined in any order to implement the method or any alternative methods so long as any such system involves the transmission of a signal within an airtight chamber to measure a parameter of gaseous sample. Additionally, individual blocks may be deleted from the method without departing from the spirit and scope of the subject matter described herein. Furthermore, the method can be implemented in any suitable hardware, software, firmware, or combination thereof.

The method 200 utilizes the system 100 configured to measure the parameter in the gaseous sample. The system 100 comprises at least one processor 102 and a memory unit integrated with the processor 102 configured to store a set of program modules executable by the processor 102 to operate the system 100. The system 100 further comprises a voltage control oscillator (VCO) 104 in communication with the processor 102, a transmitter 114 positioned at a first end 110 of an airtight chamber 108 and in communication with the VCO 104, a receiver 116 positioned at a second end 112 opposite to the first end 110, and a phase-locked loop (PLL) 106 in communication with the receiver 116 and the VCO 104.

In one embodiment, the method 200 comprises the following steps. At step 202, the VCO 104 generates a first signal having a first frequency. In one embodiment, the frequency is about 5.9 GHz.

At step 204, the transmitter 114 transmits the first signal through the gaseous sample for measuring the parameter. The transmitter 114 is in communication with the VCO 104. The gaseous sample may be a sample of a single gas or any mixture of gases with varying composition and chemistry. The gaseous sample may also have suspended particles such as dusts and other contaminants.

At step 206, the receiver 116 receives the transmitted first signal and generates a received signal. In one embodiment, the received signal is the transmitted first signal accompanied with the transmission delay while the signal is passing through the gaseous sample. In one embodiment, the receiver 116 is configured to receive the transmitted first signal and thereafter generate the received signal.

At step 208, the PLL 106 receives the received signal from the receiver 116 and synchronizes the received signal with a reference signal to generate a synchronized signal.

At step 210, the processor 102 analyzes the synchronized signal and the reference signal to compute the transmission delay between the transmission and the reception of the first signal through the gaseous sample. At step 212, the processor 102 determines a measure of the desired parameter in the gaseous sample based on the transmission delay. The measurement of the desired parameter based on the transmission delay is then output in human perceptible form, such as by displaying the information on a computer screen or printing it using a printer.

Those skilled in the art will readily recognize, in light of and in accordance with the subject matter disclosed in the present disclosure, that any of the aforementioned method steps may be implemented using at least one of a wide variety of suitable processes and system modules or system components, and is not limited to any particular computer hardware, firmware, microcode, software, middleware, and the like. The programs useable to instruct the processor 102 to perform the method steps may be written in C, C#, C++, Java, Brew, or any other suitable programming language.

For any method steps described in the present disclosure that can be carried out on a processing machine or a computing machine, the processor 102 can, when appropriately configured or designed, serve as a computer in which those aspects of the invention may be embodied. Such processors referenced and/or described in this disclosure may be any kind of computer, either general purpose, or some specific purpose computer such as, but not limited to, a workstation, a mainframe, GPU, ASIC, etc. For example, the processor 102 can be a microprocessor having program code embedded thereon, or comprise a separate computer system, either standalone or networked. Where the processor 102 is networked, t processing can be performed on one or more processors, such as in accordance with a client/server approach.

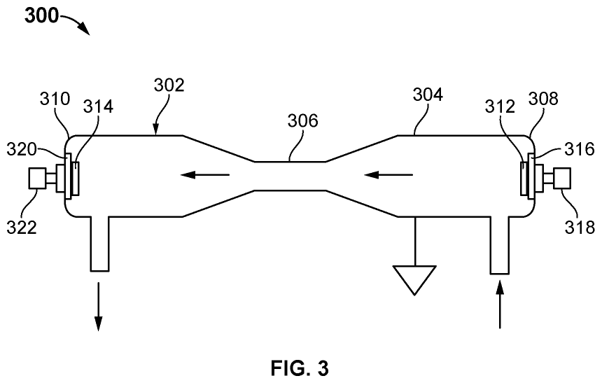

Referring to FIG. 3, a schematic diagram of an improved system 300 for measuring a parameter in a gaseous sample according to one embodiment of the present disclosure, is illustrated. The system 300 comprises a measuring device 302 comprises a chamber body 304. The chamber body 304 has a narrow middle portion 306 configured to allow the gaseous sample to pass through. The chamber body 304 further comprises at least two ends including a first end or transmission end 308 and a second end or receiving end 310. In one embodiment, the chamber body 304 further comprises one or more out ports configured to reduce interference and sensitivity of the measurement.

In one embodiment, the system 300 further comprises at least two antennas including a first antenna or a transmission/transmitting antenna 312 and a second antenna or receiver/receiving antenna 314. In one embodiment, the system 300 further comprises one or more printed circuit boards (PCB) (316, 320) including a first PCB 316 and a second PCB 320.

The transmission antenna 312 is mounted on the first PCB 316. The PCB-mounted transmission antenna 312 is mounted at the transmission end 308 of the measuring device 302. The receiving antenna 314 is mounted on the second PCB 320. The PCB-mounted receiving antenna 314 is mounted at the receiving end 310 of the measuring device 302 opposite to the transmission antenna 312.

In this embodiment, the transmission antenna 312 transmits a first signal from a signal generator to the receiver antenna 314 via the chamber body 304. The first signal is transmitted via the narrow middle portion 306 that increases the sensitivity of the measurement. In one embodiment, the narrow middle portion 306 is configured to increase the sensitivity of the measurement and reduce the time taken to reach stability and measurement. The receiver antenna 314 receives the transmitted first signal from the transmission antenna 312 and generates a received signal with a transmission delay. The difference between the transmitted first signal and the received signal is checked. The received signal is delayed due to relative humidity (Rh). The delay in the received signal is interpreted into Rh value.

The transmission delay between the transmitted first signal and the received signal is corresponding to varying parameters of the gaseous sample in the chamber body 304, thereby enhancing the accuracy of readings with reduced interference.

In one embodiment, the chamber body 304 is a glass tube having an enclosed area for the transmission of the first signal between the transmission antenna 312 and the receiver antenna 314. The glass tube enhances the accuracy of readings due to reduced interference. In one embodiment, the chamber body 304 is coated with a chromium layer at its outer surface and grounded to isolate it from the outer signal or interference from any signals from the other sources. The chamber body 304 is grounded to isolate it from any outer signal or interference from any signals from other external sources, thereby enhancing the accuracy of the readings due to reduced interference.

In one embodiment, the system 300 further comprises a phase-locked loop (PLL) (not shown in Figure) in communication with the receiver antenna 314. The PLL matches the received signal with a reference signal and adjusts the received signal with respect to the reference signal to generate a synchronized signal. In one embodiment, the synchronized signal is analyzed to compute the transmission delay between the transmission and the reception of the first signal through the gaseous sample. In one embodiment, the system 300 further comprises a shielding for the wave transmitted from the outer environment, thereby providing an uninterrupted transmission of signals inside the chamber body 304 to improve accuracy. Further, the chamber body 304 is enclosed with an external enclosure with a constant temperature to improve accuracy.

The system 300 further comprises one or more SMA (SubMiniature version A) connectors (318, 322) including a first SMA connector 318 and a second SMA connector 322. The first SMA connector 318 is mounted at the transmission end 308 of the measuring device 302 configured to connect with any of an input device that provides the first signal. The input device may be, but not limited to, a voltage control oscillator (VCO) or any other device that transmits signals and communicates with a processor and PLL. The second SMA connector 322 is mounted at the receiving end 310 of the measuring device 302 configured to connect with the PLL.

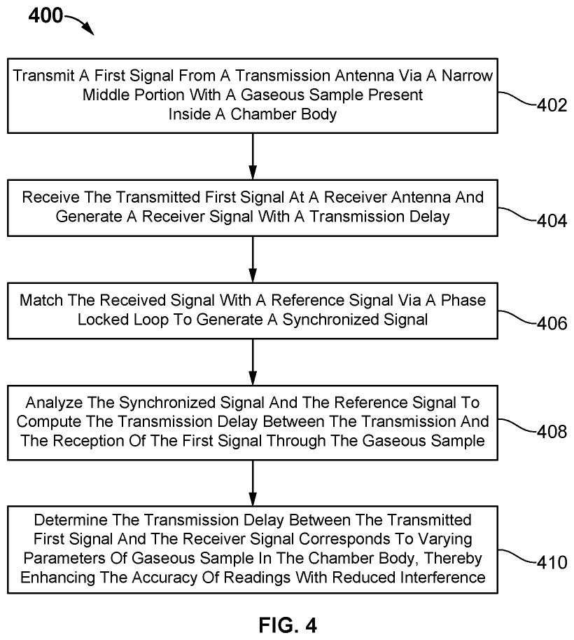

Referring to FIG. 4, a flow diagram of a method 400 for measuring a parameter in the gaseous sample according to one embodiment of the present disclosure, is illustrated. The method 400 utilizes the improved system 300 for measuring the parameter in the gaseous sample. The improved system 300 comprises a measuring device 302 having a chamber body 304 having a narrow middle portion 306. The measuring device 302 includes at least two ends such as a first end or transmission end 308 and a second end or receiving end 310. The system 300 further comprises at least two antennas (312, 314) including a first antenna or a transmission antenna 312 mounted at the transmission end 308 of the measuring device 302 and a second antenna or receiving antenna 314 mounted at the receiving end 310 of the measuring device 302 opposite to the transmission antenna 312.

In one embodiment, the method 400 comprises the following steps. At step 402, the first signal is transmitted from the transmission antenna 312 via the narrow middle portion 306 with a gaseous sample present inside the chamber body 304. The transmission antenna 312 transmits the first signal to the receiver antenna 314 via the narrow middle portion 306 of the chamber body 304 configured to increase the sensitivity of the measurement. In one embodiment, the chamber body 304 is a glass tube having an enclosed area for the transmission of the first signal between the transmission antenna 312 and the receiver antenna 314. The glass tube enhances the accuracy of readings due to reduced interference.

The chamber body 304 is coated with a chromium layer at its outer surface and grounded to isolate it from the outer signal or interference from any signals from the other sources. In one embodiment, the chamber body 304 is grounded to isolate it from any outer signal or interference from any signals from other external sources, thereby enhancing the accuracy of the readings due to reduced interference. In one embodiment, the chamber body 304 further comprises one or more out ports configured to reduce interference and improve the sensitivity of reading. Further, the chamber body 304 is enclosed with an external enclosure with a constant temperature to improve accuracy.

At step 404, the receiver antenna 314 receives the transmitted first signal and generates a received signal with a transmission delay. At step 406, the received signal is synchronized/matched with a reference signal via a phase-locked loop (PLL) to generate a synchronized signal. At step 408, the synchronized signal and the reference signal are analyzed to compute the transmission delay between the transmission and the reception of the first signal through the gaseous sample. The processor may be a digital signal processor or other types of processors, is configured to analyze the synchronized signal and the reference signal to compute the delay in the transmission of the first signal from the transmitter 114 to the receiver 116 through the gaseous sample, and determine, based on the transmission delay, a measure of the parameter in the gaseous sample.

At step 410, the transmission delay between the transmitted first signal and the received signal is determined based on the varying parameters of the gaseous sample in the chamber body 304, thereby enhancing the accuracy of readings with reduced interference. The method 400 further utilizes a shielding for the wave transmitted from the outer environment, thereby providing an uninterrupted transmission of signals inside the chamber body to improve accuracy.

### Example 1

An exemplary operation of system 100 is described herein. The system 100, in accordance with the present implementation, is configured to measure the humidity within a gaseous sample. The gaseous sample may be air or any other mixture of gases or a single type of gas. The gaseous sample, the humidity of which is to be measured, is supplied in the airtight chamber 108. A first signal at about 5.9 GHz frequency is transmitted via the transmitter 114 through the gaseous sample that is introduced in the airtight chamber 108. The transmitted first signal is received by the receiver 116 as the signal passes through the sample air. As the transmitted first signal is received by the receiver 116, the receiver 116 generates a corresponding received signal. The received signal is the first signal accompanied by the transmission delay in transmission of the first signal from the transmitter 114 to the receiver 116.

The received signal is then supplied to the PLL 106. The PLL 106 also receives a reference signal from the VCO 104. The PLL 106 is configured to match the received signal and the reference signal to generate a synchronized signal. The synchronized signal is then analyzed by the processor 102 for extracting the information pertaining to the transmission delay. As mentioned previously, the transmission delay in this example, gives the measurement of the humidity in the gaseous sample.

For translating the transmission delay into the measurement of humidity, the system 100 needs to be initially calibrated for the same. More specifically, in accordance with one implementation of the present disclosure, a completely dry gaseous sample with 0% humidity may be introduced into the airtight chamber 108, and the transmission delay for the first signal to pass through the gaseous sample may be measured, using the aforementioned implementation. It is to be noted that for the purpose of calibration, a conventional humidity sensor may be used to confirm the humidity measure of the gaseous sample being introduced into the airtight chamber 108. An example of such a conventional humidity sensor is that disclosed in U.S. Pat. No. 5,844,138 to Cota, U.S. Published Patent Application 2010/0307238 to Van Popta et al., or any other types of commercially available humidity sensors that effectively measure humidity.

The transmission delay for the transmission of the first signal from the transmitter 114 to the receiver 116 through the completely dry sample air may be recorded. Similarly, the aforementioned calibration protocol may be repeated by incrementally increasing the humidity in the sample air being introduced in the airtight chamber 108, and thereafter recording the corresponding transmission delays. The increment may be by 1% or 10% relative humidity or any other increment such that the transmission delays are obtained for a range of humidity between 0% and 100%. These values are obtained while every other parameter such as sample composition, density, temperature and pressure are kept constant while only the humidity is varied. Once a table including a humidity measurement in percentage and the corresponding transmission delays (in picoseconds) is generated, the same may be stored in the integrated memory of the processor 102.

After the table of the humidity measurement in percentage and transmission delay is generated, the processor 102 can then be configured to extract the transmission delay information associated with the sample air from the synchronized signal and map the transmission delay value with the closest humidity measurement present in the table. As such, the system 100 is, in this manner, configured to measure the humidity of the sample air without the usage of any conventional analog humidity sensor after the generation of the relevant database. An advantageous aspect of eliminating the usage of the conventional analog humidity sensor is that the processing time is significantly reduced to being almost instantaneous as the speed of the signal transmission through the gaseous sample is within thousandths of a second. This permits usage in highly time sensitive and real time applications. It also significantly reduces the typical wait times in such applications as humidity probe calibration. The processor 102 only needs to perform one operation of mapping the transmission delay against humidity measurement within the table. As such, the system 100 may be made capable of providing virtually instantaneous measurement of a particular parameter in a gaseous sample. The processor speed therefore becomes the limiting factor in the response time rather than that of a sensing material which is significantly slowed by the mechanical interaction between the gaseous sample and the sensing material.

Another advantageous aspect of such a system for measuring a parameter in a gaseous sample, in accordance with the present disclosure, is that the system 100 may be configured to measure any relevant parameter in a fluid sample. More specifically, in the aforementioned example of the system 100, the system 100 is calibrated to measure humidity in a gaseous sample. However, the system 100 may also be configured to measure any other parameter, including but not limited to, temperature, pressure, air quality, quantity, any specific contaminant in an air sample, and so on.

### Example 2

A second exemplary operation of the system 100 is described herein. The system 100, in accordance with the present implementation, is configured for measurement of a specific contaminant within a sample of air. The sample air, the level of specific contamination of which is to be measured, is supplied in the airtight chamber 108. A first signal at about 5.9 GHz frequency is transmitted via the transmitter 114 through the sample air that is introduced in the airtight chamber 108. The transmitted first signal is received by the receiver 116 as the signal passes through the sample air. As the transmitted first signal is received by the receiver 116, the receiver 116 generates a corresponding received signal. The received signal, in accordance with the present disclosure, is the first signal accompanied by the transmission delay in transmission of the first signal from the transmitter 114 to the receiver 116.

The received signal is then supplied to the PLL 106. The PLL 106 also receives a reference signal from the VCO 104. The PLL 106 is configured to match the received signal and the reference signal to generate a synchronized signal. The synchronized signal is then analyzed by the processor 102 for extracting the information pertaining to the transmission delay. As mentioned previously, the transmission delay gives the measurement of the contaminant in the gaseous sample.

For translating the transmission delay into the measurement of contamination, the system 100 needs to be initially calibrated for the same. More specifically, in accordance with one implementation of the present disclosure, a completely pure form of the gaseous sample with 0% contamination may be introduced into the airtight chamber 108, and the transmission delay for the first signal to pass through the gaseous sample may be measured, using the aforementioned implementation. The transmission delay for the transmission of the first signal from the transmitter 114 to the receiver 116 through the completely pure gaseous sample may be recorded. Similarly, the aforementioned calibration protocol may be repeated by incrementally increasing the concentration of the specific contaminant in the gaseous sample being introduced in the airtight chamber 108, and thereafter recording the corresponding transmission delays. The increment may be by 0.1%, 1% or 10% v/v or any other increment such that the transmission delays are obtained for a range of contaminations between 0% and 100%. These values are obtained with every other parameter such as humidity, gaseous sample composition, density, temperature, and pressure, kept constant while the level of contamination is varied. Once a table including contamination measurement in percentage and the corresponding transmission delays (in picoseconds) is generated, the same may be stored in the integrated memory of the processor 102.

After the table of the contamination measurement in percentage v/v and transmission delay is generated, the processor 102 can then be configured to extract the transmission delay information associated with the gaseous sample from the synchronized signal and map the transmission delay value with the closest % contamination measurement present in the database. As such, the system 100 is, in this manner, configured to measure the contamination in the gaseous sample without the usage of any conventional analog sensor after the generation of the relevant database.

### Example 3

A third exemplary operation of the system 100 is described herein, whereby the system 100, in accordance with the present implementation, is implemented within a mobile device and configured for measurement of a specific contaminant in the environment around the device within which it is implemented. To achieve this the system 100 is coupled with an automatic sampling system to periodically obtain sample air from the environment. An example of such an automatic air sampling system is presented in WO2003004996A3. This withdraws air from the surrounding environment and supplies the air sample to the airtight chamber 108. A first signal at about 5.9 GHz frequency is transmitted via the transmitter 114 through the sample air that is introduced in the airtight chamber 108. The transmitted first signal is received by the receiver 116 as the signal passes through the sample air. As the transmitted first signal is received by the receiver 116, the receiver 116 generates a corresponding received signal. The received signal, in accordance with the present disclosure, is the first signal accompanied by the transmission delay in transmission of the first signal from the transmitter 114 to the receiver 116.

The received signal is then supplied to the PLL 106. The PLL 106 also receives a reference signal from the VCO 104. The PLL 106 is configured to synchronize the received signal and the reference signal to generate a synchronized signal. The synchronized signal is then analyzed by the processor 102 for extracting the information pertaining to the transmission delay. As mentioned previously, the transmission delay gives the measurement of the contaminant in the gaseous sample.

For translating the transmission delay into the measurement of contamination, the system 100 needs to be initially calibrated for the same. More specifically, in accordance with one implementation of the present disclosure, a completely pure gaseous sample with 0% contamination may be introduced into the airtight chamber 108, and the transmission delay for the first signal to pass through the gaseous sample may be measured, using the aforementioned implementation. The transmission delay for the transmission of the first signal from the transmitter 114 to the receiver 116 through the pure sample air may be recorded.

Similarly, the aforementioned calibration protocol may be repeated by incrementally increasing the concentration of the specific contaminant in the gaseous sample being introduced in the airtight chamber 108, and thereafter recording the corresponding transmission delays. The increment may be by 0.1%, 1% or 10% v/v or any other increment. Such that the transmission delays are obtained for a range of contaminations between 0% and 100%. At constant transmission distance, the trajectory of the signal is affected by the properties of the medium through which it travels, in this case the gaseous sample. These values are obtained with every other parameter such as humidity, gaseous sample composition, density, temperature, and pressure, kept constant while the level of contamination is varied. Once a table including contamination measurement in percentage and the corresponding transmission delays (in picoseconds) is generated, the same may be stored in the integrated memory of the processor 102.

After the table of the contamination measurement in percentage v/v and transmission delay is generated, the processor 102 can then be configured to extract the transmission delay information associated with the sample air from the synchronized signal and map the transmission delay value with the closest % contamination measurement present in the database. As such, the system 100 is, in this manner, configured to measure the contamination in the gaseous sample without the usage of any conventional analog sensor after the generation of the relevant database.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for measuring a parameter in a gaseous sample, the system comprising:
a measuring device includes a chamber body having a narrow middle portion and at least two ends including a first end or transmission end and a second end or receiving end, wherein the narrow middle portion is configured to allow a gaseous sample to pass through, and one or more out ports to reduce interference, and
at least two antennas including a first antenna or a transmission antenna mounted at the first end of the measuring device and a second antenna or receiving antenna mounted at the second end of the measuring device opposite to the transmission antenna;
wherein the transmission antenna transmits a first signal to the receiver antenna via the chamber body, wherein the first signal is transmitted via the narrow middle portion that increases sensitivity of measurement;
wherein the receiver antenna receives the transmitted first signal from the transmitter antenna and generates a received signal with a transmission delay, and
wherein the transmission delay between the transmitted first signal and the received signal is corresponding to varying parameters of the gaseous sample in the chamber body, thereby enhancing the accuracy of readings with reduced interference.

2. The system of claim 1, further comprises a phase-locked loop in communication with the receiver antenna configured to match the received signal with a reference signal and adjust the received signal with respect to reference signal to generate a synchronized signal.

3. The system of claim 1, wherein the synchronized signal is analyzed to compute the transmission delay between the transmission and the reception of the first signal through the gaseous sample.

4. The system of claim 1, wherein the chamber body is a glass tube having an enclosed area for the transmission of the first signal between the transmission antenna and the receiver antenna.

5. The system of claim 4, wherein the glass tube enhances the accuracy of readings due to reduced interference.

6. The system of claim 1, wherein the chamber body is coated with a chromium layer at its outer surface and grounded to isolate it from the outer signal or interference from any signals from the other sources, thereby enhancing the accuracy of the readings due to reduced interference.

7. The system of claim 1, wherein the antenna transmits the first signal to the receiver antenna via the narrow middle portion of the chamber body configured to increase the sensitivity of measurement and reduce the time taken to reach stability and measurement.

8. The system of claim 1, wherein out ports are configured to reduce interference and improve the sensitivity of measurement.

9. The system of claim 1, further comprises a shielding for wave transmitted from the outer environment, thereby providing an uninterrupted transmission of signals inside the chamber body to improve accuracy.

10. The system of claim 1, wherein the chamber body is enclosed with an external enclosure with a constant temperature to improve accuracy.

11. A method for measuring a parameter in a gaseous sample using a system comprising a measuring device having a chamber body and at least two ends including a first end or transmission end and a second end or receiving end; at least two antennas including a first antenna or a transmission antenna mounted at the first end of the measuring device and a second antenna or receiving antenna mounted at the second end of the measuring device opposite to the transmission antenna, wherein the method comprises the steps of:
transmitting a first signal from the transmission antenna via a narrow middle portion with a gaseous sample present inside the chamber body;
receiving the transmitted first signal at the receiver antenna and generating a received signal with a transmission delay;
matching the received signal with a reference signal via a phase-locked loop to generate a synchronized signal;
analyzing the synchronized signal and the reference signal to compute the transmission delay between the transmission and the reception of the first signal through the gaseous sample, and
determining the transmission delay between the transmitted first signal and the received signal corresponds to varying parameters of the gaseous sample in the chamber body, thereby enhancing the accuracy of readings with reduced interference.

12. The method of claim 11, wherein the transmission antenna transmits the first signal to the receiver antenna via the narrow middle portion of the chamber body configured to increase sensitivity of measurement.

13. The method of claim 11, wherein the chamber body is a glass tube having an enclosed area for the transmission of the first signal between the transmission antenna and the receiver antenna.

14. The method of claim 13, wherein the glass tube enhances the accuracy of readings due to reduced interference.

15. The method of claim 11, wherein the chamber body is coated with a chromium layer at its outer surface and grounded to isolate it from the outer signal or interference from any signals from the other sources, thereby enhancing the accuracy of the readings due to reduced interference.

16. The method of claim 11, wherein the chamber body comprises one or more out ports configured to reduce interference and improve the sensitivity of reading.

17. The method of claim 11, providing a shielding for the wave transmitted from the outer environment, thereby providing an uninterrupted transmission of signals inside the chamber body to improve accuracy.

18. The method of claim 11, wherein the chamber body is enclosed with an external enclosure with a constant temperature to improve accuracy.
